(19) United States
(12) Patent Application Publication
(10) Pub. No.: US 2022/0213796 A1
(43) Pub. Date: Jul. 7, 2022

(54) TURBOMACHINE WITH LOW LEAKAGE SEAL ASSEMBLY FOR COMBUSTOR-TURBINE INTERFACE

(71) Applicant: HONEYWELL INTERNATIONAL INC., Charlotte, NC (US)

(72) Inventors: Nagaraja Rudrapatna, Chandler, AZ (US); Thomas Bronson, Mesa, AZ (US); David Chou, Phoenix, AZ (US); Christopher Zollars, Tempe, AZ (US)

(73) Assignee: HONEYWELL INTERNATIONAL INC., Charlotte, NC (US)

(21) Appl. No.: 17/142,460

(22) Filed: Jan. 6, 2021

(51) Int. Cl. F01D 9/02; F23R 3/00; F23R 3/54; F23R 3/60

(52) U.S. Cl. CPC F01D 9/023; F23R 3/002; F05D 2240/55; F23R 3/60; F05D 2240/35; F23R 3/54

(57) ABSTRACT

A low-leakage seal assembly for a turbomachine's combustor-turbine interface. A turbomachine includes a combustion chamber that receives compressed air for combustion from a compressor. The combustion chamber is defined by a combustion liner terminating in a seal ring where the seal ring has an enlarged head that is thicker than the remainder of the seal ring. A transition liner directs combustion gases from the combustion chamber to the turbine and has three walls forming a cavity with an open end. The seal ring extends through the open end and the head nests in the cavity. The transition liner and the seal ring are parts of a low-leakage seal assembly that is exposed on one side to the compressed air and that is exposed on another side to the combustion gases.

### STATEMENT REGARDING FEDERALLY SPONSORED RESEARCH OR DEVELOPMENT

This invention was made with Government support under contract number FA8650-15-D-2504 awarded by the United States Air Force Research Lab. The Government has certain rights in the invention.

### TECHNICAL FIELD

Embodiments of the subject matter described herein generally relate to improved sealing for efficiency and operational enhancement in turbomachinery. More particularly, embodiments of the subject matter relate to low leakage seal assemblies for a combustor-turbine interface area.

### BACKGROUND

A turbomachine such as a gas turbine engine may be used to power various types of vehicles and/or systems. Gas turbine engines typically include a compressor that receives and compresses incoming gas such as air; a combustor in which the compressed gas is mixed with fuel and burned to produce high-pressure and high-velocity exhaust gas; and one or more turbines that extract energy from the exhaust gas exiting the combustor.

Interfaces between the combustor and the turbine may be prone to leakage due to the extreme thermal gradients that result from temperature fluctuations in the air exhausted from the combustor, as well as the temperature differentials between the air exhausted from the combustor and the engine's air plenums. As a result of thermal growth, leakage paths may increase between mating components even if such components fit closely in a normal, pre-combustion state. Uncontrolled air leakage across interfaces has an impact on gas turbine engine performance and therefore, is undesirable.

In gas turbine engines, relatively cool air from the compressor may be routed around the combustor prior to entry into the combustion chamber and to cool components. Leaks between the combustion gases and the cool incoming air may occur through gaps between components. The need to assemble a number of individual components in fabricating the engine inherently results in potential gaps between parts, such as due to tolerance variations. In addition, operational ranges of a gas turbine may result in significant thermal expansion, increasing challenges in maintaining a tight seal at interfaces. Leakage flow at the interface of the combustor and the turbine, in particular, interacts with the flow field entering the turbine resulting in less than optimal combustor exit temperatures and temperature distributions. As designed turbine inlet temperatures are increasing to accomplish new performance objectives such as engine specific fuel consumption improvements, there is an increasing need to reduce the possibility of leakage. Therefore, an increasing need exists to provide sealing arrangements that minimize leakage across the combustor-turbine interface without compromising ease of assembly, while simultaneously addressing the differential thermal growth that occurs.

Accordingly, it is desirable to provide improved sealing approaches for interfaces in turbomachines. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

This summary is provided to describe select concepts in a simplified form that are further described in the Detailed Description section of this disclosure. This summary is not intended to identify key or essential features of the claimed subject matter, nor is it intended to be used as an aid in determining the scope of the claimed subject matter.

In a number of embodiments, a turbomachine includes a combustion chamber configured to receive air for combustion. The combustion chamber is defined by a combustion liner terminating in a seal ring that extends from the combustion liner to a terminal end. The combustion liner includes a head at the terminal end that has a pair of sealing surfaces. A turbine receives combusted gases from the combustor, and a transition liner directs the combustion gases to the turbine. The transition liner has walls on three sides of the head forming a cavity with an open end. The seal ring extends through the open end and the head is disposed in the cavity, with each of the sealing surfaces facing one of the walls.

In other embodiments, a turbomachine includes a compressor configured to generate compressed air. A combustion chamber receives the compressed air and is defined by a combustion liner terminating in a seal ring. The seal ring has an enlarged a head that is thicker than the combustion liner. A combustor casing surrounds the combustor and defines an air plenum around the combustor that is configured to receive the compressed air. A turbine is configured to receive combusted gases from the combustor. A transition liner directs the combustion gases generated in the combustion chamber toward the turbine. The transition liner has three walls forming a cavity with an open end. The seal ring extends through the open end, and the head nests in the cavity. The transition liner and the seal ring comprise a seal assembly that is exposed on one side to the compressed air and that is exposed on another side to the combustion gases.

In additional embodiments, a turbomachine includes a compressor configured to generate compressed air and a combustion chamber that receives the compressed air for combustion. The combustion chamber is defined by a combustion liner, with a seal ring extending from the combustion liner to a terminal end. The seal ring has an enlarged head that is thicker than the combustion liner. A turbine is configured to receive combusted gases from the combustor and a transition liner directs the combustion gases generated in the combustion chamber to the turbine. The transition liner has an inner wall on one side of the head, an outer wall on another side of the head, and an end wall extending between the first and second walls adjacent the terminal end. The walls form a cavity with an open end. The seal ring extends through the open end and the head nests in the cavity. Variable gaps are defined between the walls and the head. The head is disposed with a bias toward one of the inner and outer walls when the turbomachine is assembled.

### BRIEF DESCRIPTION OF THE DRAWINGS

The present invention will hereinafter be described in conjunction with the following drawing figures, wherein like numerals denote like elements, and wherein:

FIG. 1 is a schematic cross-sectional illustration of a turbomachine in the form of a gas turbine engine, according to an exemplary embodiment;

FIG. 2 is a fragmentary, cross-sectional illustration of part of the engine of FIG. 1, according to an exemplary embodiment;

FIG. 3 is a fragmentary, cross-sectional illustration of a seal assembly area for the engine of FIG. 1 in a first state, according to an exemplary embodiment;

FIG. 4 is a fragmentary, cross-sectional illustration of the seal assembly area of FIG. 3 in a second state, according to an exemplary embodiment;

FIG. 5 is a graph demonstrating gap influence on profile and pattern factors of a gas turbine engine shown as impact on temperature distribution in percent; and

FIG. 6 is a fragmentary, cross-sectional illustration of an alternate seal assembly area for the engine of FIG. 2, according to an exemplary embodiment.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

In a number of embodiments, turbomachine gap leakage is minimized by an active seal assembly that compensates for differential thermal growth and provides ease of assembly. An exemplary turbomachine may include a compressor configured to generate compressed air. A combustion chamber receives the compressed air for combustion, and is defined by a combustion liner. The combustion liner, such as at its inner combustion liner, terminates in an extending seal ring that may comprise a material that is thicker than the rest of the liner. Due to the increased thickness, the seal ring presents an enlarged head with at least two sealing surfaces. A transition liner directs the combustion gases from the combustion chamber to the turbine. The transition liner has an inner wall, an outer wall and an end wall forming an annular cavity with an open end. The head extends through the open end and nests in the cavity. During thermal expansion and contraction, the head is moveable in the cavity between the walls to maintain a minimal gap between the sealing surfaces of the head and the outer/inner walls. In a number of embodiments, sealing may also be provided between the head and the end wall. In some embodiments a compressible seal may be disposed between the head and the end wall. Providing multiple sealing points in one structural combination ensures adequate sealing engagement under all conditions between the combustor liner sealing ring and the inner transition liner.

In embodiments and examples described herein, applications such as turbomachines with seal assemblies may be described in association with an aircraft turboprop engine, but the disclosure is not limited in utility to such an application. In the example of a turboprop engine, the transition between the combustor and the turbine has a complex shape, and pressurized air delivered from the compressor may reside in a plenum located outside the combustor and the transition. Any uncontrolled gaps would allow leakage between the plenum and the transition. Uncontrolled air leakage from the plenum would impact gas turbine engine performance and so controlling leakage is beneficial in a turboprop engine. In addition, the embodiments disclosed herein have applicability where leakage control at interfacing components is similarly desirable. For example, various other engine environments, as well as different types of rotating or otherwise moving machinery will benefit from the features described herein. Thus, no particular feature or characteristic is constrained to an aircraft, an aircraft engine, or a turboprop engine, and the principles disclosed herein may be embodied in other vehicles, and/or in other turbomachinery or equipment.

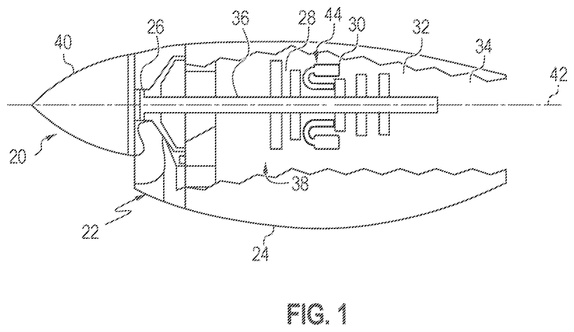

A schematic, partially sectioned view of the engine assembly 20 is shown in FIG. 1 according to an exemplary embodiment. The engine assembly 20 in general, includes an inlet section 22, a gearbox 26, a compressor section 28, a combustion section 30, a turbine section 32, and an exhaust section 34, all of which may be disposed within, or defined by, a cowling 24. The compressor section 28, the combustion section 30, the turbine section 32, and the exhaust section 34 may collectively be referred to as the engine core 38. During operation, air enters the inlet section 22 from atmosphere and is directed into the compressor section 28. The compressor section 28 may include a series of compressor impellers that increase the pressure of the air, which is then directed toward the combustion section 30, such as by ducting (not shown). In this embodiment, the compressor section 28 includes a rotor with a two-stage axial compressor rotating about an axis 42. In other embodiments, any number of stages or compressor types, such as axial or centrifugal, including a single stage may be employed. In the combustion section 30, the high-pressure air from the compressor section 28 is mixed with fuel and combusted. The gases from the combusted fuel and air are then directed into the turbine section 32. The turbine section 32 includes a rotor with a series of turbines, which may be disposed in axial flow series or in other arrangements and which also rotate about the axis 42. The combustion gas from the combustion section 30 expands through, and rotates, the rotor of the turbine section 32, from which power is derived. From the turbine section 32, the air is then exhausted from the engine core 38 through the exhaust section 34 to the atmosphere.

In the exemplary embodiment, the rotor of the turbine section 32 is coupled to one or more shafts 36 to drive equipment in the engine assembly 20. Specifically, the turbines may drive the rotor of the compressor section 28. The shaft 36 may additionally be coupled to a hub 40 via the gearbox 26. A propeller (not shown) may be mounted on the hub 40 and may also be driven by the turbine section 32. Operation of the engine assembly 20 may be conducted over a wide range of ambient conditions and in response to a various operational demands. As described herein, exemplary embodiments ensure adequate leakage control is provided between areas that contain the compressed air and the combustion gases, including as temperature and resulting thermal expansion fluctuate.

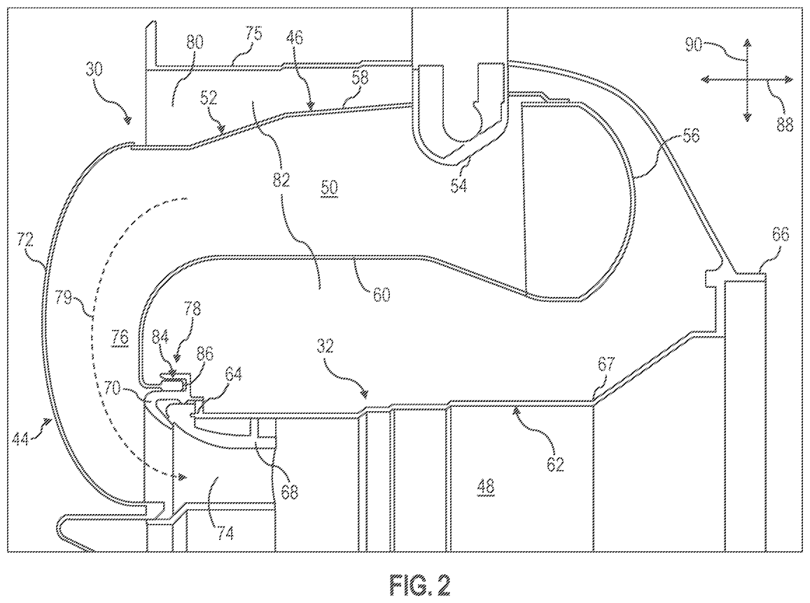

Referring additionally to FIG. 2, illustrated is a fragmentary, cross-sectional view of an embodiment of a combustor-turbine transition area 44, such as of the engine assembly 20 of FIG. 1. A reverse flow combustor 46 is included which turns combustion gas flow 180° prior to entry to the turbine section 32. In this embodiment, the combustor 46 is generally disposed radially outward from a turbine plenum 48 of the turbine section 32 and is configured to contain the turbine rotor. The combustor 46 includes a combustion chamber 50 that is generally annular in shape and is defined by a liner assembly 52. The combustor 46 also includes a plurality of shrouded injectors 54 for delivering fuel and air to the combustion chamber 50. The liner assembly 52 generally includes a dome assembly 56, an outer combustor liner 58 and an inner combustor liner 60. The turbine plenum 48 is defined by a turbine shroud assembly 62 that surrounds the turbine rotor (FIG. 1), and that channels the combustion gases therethrough. The turbine shroud assembly 62 is generally of a stepped cylindrical shape of various diameters to contain different sized blade sets and includes a turbine shroud 67 that extends from an inlet end 64 to an outlet end 66. A shroud ring 68 is disposed at the inlet end 64 and engages an inner transition liner 70 that is disposed between the inner combustor liner 60 and the turbine shroud assembly 62. An outer transition liner 72 extends from the outer combustor liner 58 to the shroud ring 68. The shroud ring 68 defines an annular nozzle opening 74 through which combustion gases are channeled to the turbine section 32.

The combustion chamber 50 is fluidly coupled to receive compressed air supplied from the compressor section 28 and more particularly through the injectors 54, through the dome 56, and in a number of embodiments, through a number of openings (not shown) in the outer and inner combustor liners 58, 60. It should be appreciated that the openings may be provided at multiple locations to permit controlled flow through the liner assembly 52, while uncontrolled flow at other locations, such as at component interfaces, is not desired. Fuel and air is supplied to the combustion chamber is ignited within the combustion chamber 50 by one or more igniters (not shown), generating combustion gas. The combustion gas flowstream 79 then flows through a transition liner passageway 76 which directs it into the turbine section 32.

The combustor 46 is mounted within a combustor casing 75, which is disposed radially outward of, and at least partially surrounds, the outer combustor liner 58. Together, the combustor casing 75 and the outer combustor liner 58 at least partially define a compressed air passageway 80 for the flow of compressed air from the compressor section 28 to the combustor 46. The passageway 80 delivers compressed air which pressurizes an air plenum 82 that surrounds the combustor 46 and is disposed both radially outside the outer combustor liner 58 and radially inside the inner combustor liner 60. As such, the compressed air is delivered to the area outside the transition liner passageway 76, including at the inner transition liner 70. The compressed air in the air plenum 82, in addition to being delivered to the combustion chamber 50, may advantageously provide cooling for the components exposed to the hot combustion gases.

For various purposes including to aid in assembly, the liner structure is fabricated from various individual liner components requiring effective interfaces to provide a controlled space. For enhanced control of the combustion gas space, a seal assembly 78 is disposed at the interface 84 between the inner combustor liner 60 and the inner transition liner 70 to control leakage through the joint between the components. The interface 84 is positioned at a relatively tight bend of the liner structure near the area where the combustion gases are turned and directed into the turbine section 32. The interface 84 is also located at an area where temperatures reach very high levels. The seal assembly 78 includes the terminal end 86 of the inner combustion liner 60 and includes the inner transition liner 70. The seal assembly 78 is configured to actively compensate for thermal expansion of the components, which may occur at different rates in the individual components. For example, as a result of combustion in the combustion chamber 50, the terminal end 86 of the inner combustor liner 60 may move in the axial direction 88 relative to the inner transition liner 70 and may move in the radial direction 90 relative to the inner transition liner 70. As a result, differential thermal expansion between the combustor liner 60 and the inner transition liner 70 is accommodated by allowing relative movement, while the sealing properties are maintained as further described below.

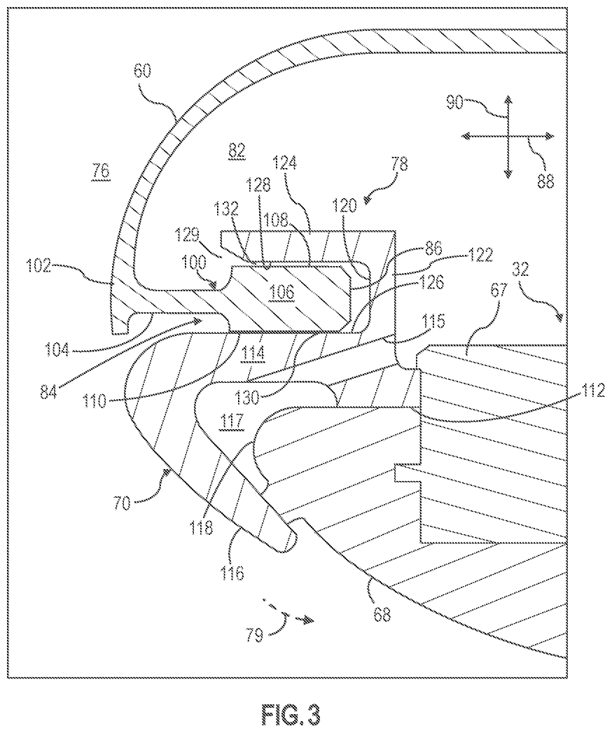

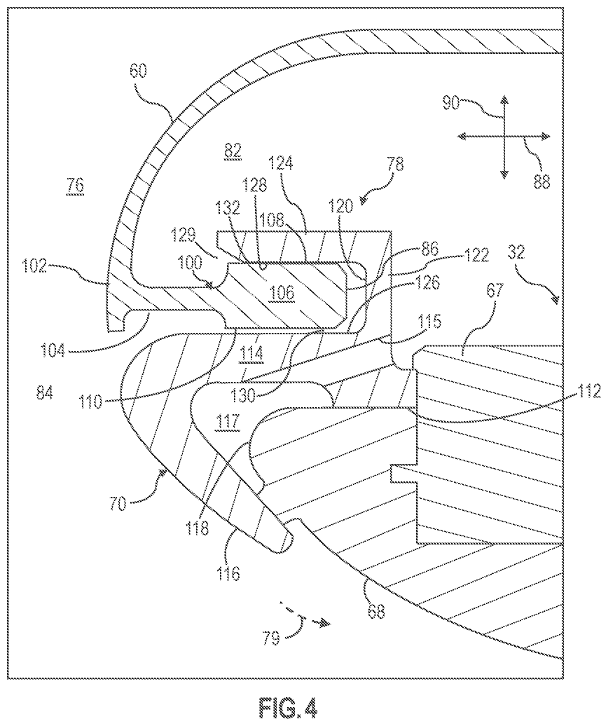

Referring to FIGS. 3 and 4, fragmentary, detail cross sections of the area at the seal assembly 78 are shown. In general, the inner combustor liner 60, the inner transition liner 70, the shroud ring 68, and the turbine shroud 67 come together in the area of the seal assembly 78. As noted, uncontrolled leakage across interfaces such as at the interface 84, impacts gas turbine engine performance. The combustor-turbine interface 84 is a very sensitive region to leakage. Component tolerances are included for these surfaces to accommodate engine assembly which results in gap variability from engine to engine. Further, during hot conditions differential thermal growth may further open gaps, increasing leakage. To control leakage at the inner combustor-turbine interface 84, the seal assembly 78 includes features to compensate for differential thermal expansion. In other words, the seal assembly 78 actively controls leakage to avoid conditions where temperature distribution in the gas flow stream 79 entering the turbine section 32 is negatively impacted, and to maintain temperature distribution both radially and circumferentially in the flowstream 79.

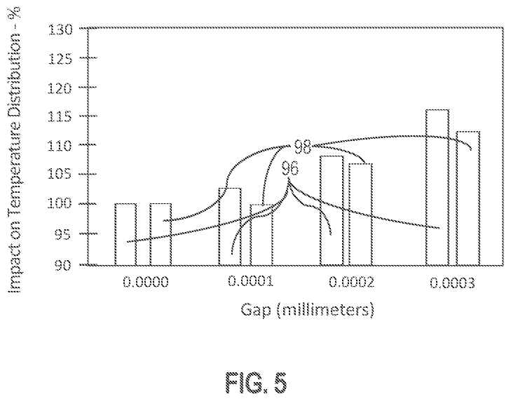

Uncontrolled leakage across this interface 84 would negatively impact performance and durability, and may disturb the designed flow field. In addition, uncontrolled leakage influences combustor exit temperature distribution and may affect turbine durability. Referring to FIG. 5, performance factor values are indicated on the vertical axis and gap size is indicated on the horizontal axis for both radial profile factors 96 and pattern factors 98 shown in a normalized fashion as impact on temperature distribution in percent. From a radial temperature distribution perspective, the chart shows that uncontrolled leakage increases lead to an increasing radial profile factor 96, which may tend to increase temperatures midstream. The radial profile factor describes the radial temperature distribution in the flow stream 79, with a higher factor indicating undesirable greater temperature differences. From a circumferential temperature distribution perspective, uncontrolled leakage leads to an increasing pattern factor 98 as also shown in the chart, which represents undesirable higher circumferential temperature distribution differences. Increased profile and pattern factors lead to less than optimal conditions from efficiency, operational and durability perspectives and therefore, the seal assembly 78 minimizes leakage.

As shown in FIG. 3, the inner combustor liner 60 includes an inner seal ring 100, that, in this embodiment, extends from a combustor curl section 102 in the axial direction 88. The inner seal ring 100 includes a segment 104 that connects a head 106 to the combustor curl section 102 and that projects in the axial direction 88. The head 106 extends from the segment 104 to the terminal end 86. As such, the head 106 presents a radially outward facing annular surface 108 and a radially inward facing annular surface 110. The surfaces 108, 110 are sealing surfaces configured to inhibit leakage. As such, in the current embodiment the surfaces 108, 110 are machined during fabrication to present a precise sealing surface with good circularity. The head 106 is enlarged in thickness relative to the segment 104 to provide rigidity for fabrication processing and to maintain circularity.

The inner transition liner 70 includes an opening 112 that is defined by a ring-shaped base wall 114. The base wall 114 may also be referred to as an inner wall in this embodiment due to its location. The opening 112 receives the shroud ring 68 and the base wall 114 abuts the turbine shroud 67. A liner section 116 extends from the base wall 114 and curls radially inward around the end 118 of the shroud ring 68. An opening 115 extends through the base wall 114 allowing cooling air from the air plenum 82 to into a cavity 117 to cool the liner section 116, which is exposed directly to the combustion gases passing through the transition liner passageway 76. A cavity 120 is defined by the inner transition liner 70 and presents a receptacle in which the head 106 of the inner seal ring 100 may nest. The cavity 120 is annular in shape, and includes three closed sides defined by the base wall 114 which comprises an inner wall, a radially extending end wall 122 and an axially extending outer wall 124. The end wall 122 connects the outer wall 124 with the base wall 114. The inner wall (base wall 114) and the outer wall 124 oppose each other across the cavity 120 and present sealing surfaces 126, 128, respectively. The sealing surfaces 126, 128 may be machined during fabrication to present precise sealing surfaces with good circularity. The sealing surface 126 is disposed adjacent to, and faces, the annular surface 110 of the head 106. The sealing surface 128 is disposed adjacent to, and faces, the annular surface 108 of the head 106. The inner/base wall 114, the end wall 122, and the outer wall 124 define three sides of the cavity 120 and present an open end 129 through which the head 106 is received during assembly.

The engine assembly 20 is fabricated with tolerances for the dimensions of each component. With a possibility for up to a minimum-maximum tolerance range combination between a pair of mating components fabricated according to specifications, the potential for gaps exists. A larger gap leads to an increased potential for leakage. In the current embodiment, the tolerances are selected to bias the head 106 to initially be positioned closer to one of the walls, in this embodiment the base wall 114. As the inner combustor liner 60 is subjected to heat loads, thermal expansion has an effect on position of the head 106 relative to the inner transition liner 70. In the current embodiment, it has been determined that the head 106 has a tendency to move in a variety of ways, including radially outward relative to the inner transition liner 70. Therefore, the head 106 is designed with tolerances biased inward for cold positioning adjacent the inner/base wall 114. Accordingly, when cold the annular surface 110 is disposed very close to, or against, the sealing surface 126 with a minimal or zero gap 130. Concurrently, the annular surface 108 is disposed away from the sealing surface 128 defining a slightly larger gap 132 that facilitates assembly when the parts are mated. When the combustion process generates heat, the head 106 moves relative to the inner transition liner 70 such that the gap 130 opens and the gap 132 simultaneously closes. Leakage is controlled by the two alternate engaging sealing surface pairs, wherein when the gap 132 is open, the gap 130 is closed (FIG. 3) and when the gap 130 is open, the gap 132 is closed (FIG. 4). Accordingly, one of the gaps 130, 132 may, at a given point in time, comprise a zero gap when completely closed by its respective mating surfaces. As used herein, the term gap includes a variable gap that may, at times, close but is are still referred to as a gap. It will be appreciated that in other embodiments, the head 106 and the inner transition liner 70 may respond to thermal loads in different ways. For example, the head 106 may move radially inward relative to the inner transition liner 70 when heated. In addition, the head 106 may move axially relative to the inner transition liner 70 when heated.

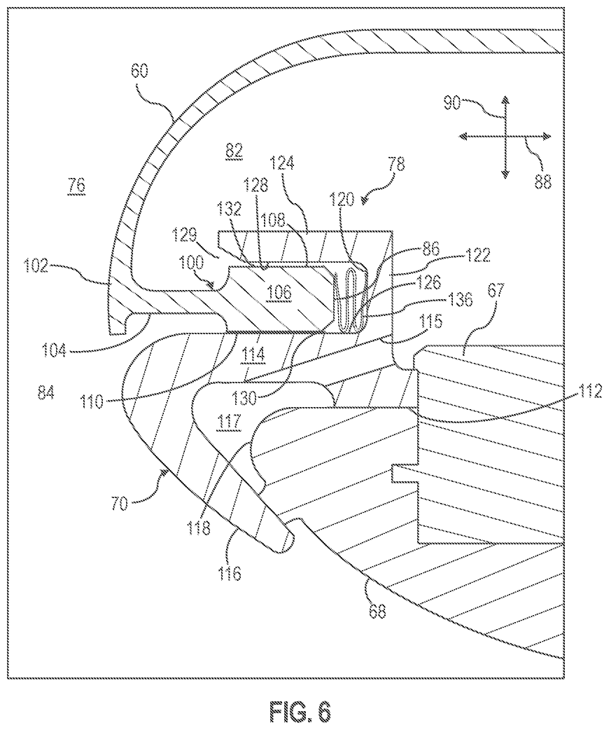

An additional element is shown in FIG. 6 where the seal assembly 78 includes a seal 136 disposed in the cavity 120. The seal 136 is compressed between the head 106 and the end wall 122. In a number of embodiments, a W-seal is included as the seal 136, which is a compression seal that relies on force created by “W” configuration to apply continuous pressure against the head 106 and the end wall 122 to maintain the sealed path in an airtight condition. In other embodiments, other seal types may be used. The seal 136 ensures substantially no leakage because it remains in contact with both the head 106 and the end wall 122 even in cases where they may move relative to one another in the axial direction 88. Advantageously, the seal 136 is contained in the cavity 120 by being completely surrounded by the head 106, and the walls 114, 122, 124.

Through the foregoing embodiments, a low-leakage seal assembly, such as for a combustor-turbine interface, is provided that may reduce leakage by over fifty-percent compared to other designs. Gaps are actively controlled when the engine is operating by allowing differential movement, axial and radial, between the combustor inner liner seal ring and the inner transition liner. The seal assembly accommodates radial growth to ensure adequate sealing engagement at all conditions. In addition, the seal assembly design incorporates tolerances that accommodate assembly considerations for use without changes to engine assembly sequences.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A turbomachine comprising:
A combustion liner defining a combustion chamber configured to receive air for combustion, the combustion liner terminating in a seal ring that extends from the combustion liner to a terminal end, the combustion liner including a head at the terminal end, the head having first and second sealing surfaces;
a turbine, configured to receive combusted gases from the combustor; and
a transition liner configured to direct the combustion gases generated in the combustion chamber to the turbine, the transition liner having a first wall extending on a first side of the head and facing the first sealing surface, a second wall extending on a second side of the head and facing the second sealing surface, and a third wall extending between the first and second walls adjacent the terminal end, the first, second and third walls forming a cavity with an open end, wherein the seal ring extends through the open end and the head is disposed in the cavity.

2. The turbomachine of claim 1, wherein:
a first gap is defined between the first wall and the head and a second gap is defined between the second wall and the head; and
the head is configured to move between the first and second walls in response to thermal loads where the first gap closes when the second gap opens and the second gap closes when the first gap opens.

3. The turbomachine of claim 1, wherein a seal is disposed in the cavity and is compressed between the head and the end wall.

4. The turbomachine of claim 1, wherein the head includes a first machined surface facing the inner wall and includes a second machined surface facing the outer wall.

5. The turbomachine of claim 1, wherein the head is configured to be disposed with a position bias toward one of the inner and outer walls when the turbomachine is assembled.

6. The turbomachine of claim 1, wherein the transition liner comprises an inner transition liner that includes the first wall and includes a liner section extending from the first wall, wherein the liner section is configured to be exposed directly to both the combustion gases and to the air.

7. The turbomachine of claim 1, wherein a pressurized air plenum is defined adjacent the seal assembly, the pressurized air plenum configured to receive the air.

8. The turbomachine of claim 7, wherein an opening extends through the first wall and registers with the pressurized air plenum.

9. The turbomachine of claim 1, wherein:
the combustor liner includes a combustor curl section;
the combustor comprises a reverse flow combustor; and
the seal ring extends from the combustor curl section.

10. The turbomachine of claim 1, wherein the transition liner is configured so that the head is insertable through the open end during assembly.

11. A turbomachine comprising:
a compressor configured to generate compressed air;
a combustion chamber receiving the compressed air from the compressor for combustion, the combustion chamber defined by a combustion liner terminating in a seal ring that extends from the combustion liner to a terminal end, the combustion liner having a first thickness and the seal ring having a head that is enlarged to have a second thickness, wherein the second thickness is greater than the first thickness;
a combustor casing surrounding the combustor and defining an air plenum around the combustor that is configured to receive the compressed air;
a turbine, configured to receive combusted gases from the combustor;
a transition liner configured to direct the combustion gases generated in the combustion chamber to the turbine, the transition liner having a first wall extending on a first side of the head, a second wall extending on a second side of the head, and a third wall extending between the first and second walls adjacent the terminal end, the first, second and third walls forming a cavity with an open end, wherein the seal ring extends through the open end and the head nests in the cavity; and
wherein the transition liner and the seal ring comprise a seal assembly that is exposed on one side to the compressed air and that is exposed on another side to the combustion gases.

12. The turbomachine of claim 11, wherein:
a first variable gap is defined between the first wall and the head and a second variable gap is defined between the second wall and the head; and
the head is configured to move between the first and second walls in response to thermal loads where the first variable gap closes when the second variable gap opens and the second variable gap closes when the first variable gap opens.

13. The turbomachine of claim 11, wherein a compressible seal is disposed in the cavity and is compressed between the head and the end wall.

14. The turbomachine of claim 11, wherein the head is shaped as an enlarged end of the seal ring, the head including a first machined surface facing the inner wall and a second machined surface facing the outer wall.

15. The turbomachine of claim 11, wherein:
a first variable gap is defined between the first wall and the head and a second variable gap is defined between the second wall and the head; and
the head is configured to be disposed with a bias toward one of the first and second walls when the turbomachine is assembled, meaning one of the first and second variable gaps is at least substantially closed.

16. The turbomachine of claim 11, wherein the transition liner comprises an inner transition liner that includes the first wall, and a liner section extending from the first wall, wherein the liner section is configured to be exposed directly to both the combustion gases and the compressed air.

17. The turbomachine of claim 11, wherein:
a pressurized air plenum is defined adjacent the seal assembly and receives the compressed air; and
an opening extends through the first wall and registers with the pressurized air plenum.

18. The turbomachine of claim 11, wherein:
the combustor liner includes a combustor curl section;
the combustor comprises a reverse flow combustor; and
the seal ring extends from the combustor curl section.

19. The turbomachine of claim 11, wherein the transition liner is configured so that the head is insertable through the open end during assembly.

20. A turbomachine comprising:
a compressor configured to generate compressed air;
a combustion chamber receiving the compressed air from the compressor for combustion, the combustion chamber defined by a combustion liner terminating in a seal ring that extends from the combustion liner to a terminal end, the combustion liner having a first thickness and the seal ring having a head that is enlarged to have a second thickness that is greater than the first thickness;
a turbine, configured to receive combustion gases from the combustor;
a transition liner for directing the combustion gases generated in the combustion chamber to the turbine, the transition liner having an inner wall extending on a first side of the head, an outer wall extending on a second side of the head, and an end wall extending between the inner and outer walls adjacent the terminal end, the inner, outer and end walls forming a cavity with an open end, wherein the seal ring extends through the open end and the head nests in the cavity;
wherein a first variable gap is defined between the inner wall and the head, and a second variable gap is defined between the outer wall and the head; and
wherein the head is configured to be disposed with a position bias toward one of the inner and outer walls when the turbomachine is assembled.
